(19) United States
(12) Patent Application Publication
(10) Pub. No.: US 2026/0340319 A1
(43) Pub. Date: Oct. 29, 2026

(54) Smart Tool for Realistic Communication between Sign Languages and Natural Languages

(71) Applicant: Parul Yadav, Pittsburgh, PA (US)

(72) Inventor: Parul Yadav, Pittsburgh, PA (US)

(21) Appl. No.: 19/439,415

(22) Filed: Jan. 4, 2026

Related U.S. Application Data
(60) Provisional application No. 63/741,967, filed on Jan. 5, 2025.

(51) Int. Cl. G06F 40/58; G09B 21/00

(52) U.S. Cl. CPC G06F 40/58; G09B 21/009

(57) ABSTRACT

All individuals, including those with hearing impairments who use sign language as a primary means of communication, have the fundamental right to express themselves and to understand others in their own language with the same appearance and feelings. Communication barriers persist due to the existence of more than 7000 natural/verbal languages and 300 distinct sign/visual languages worldwide, each with unique linguistic structures. The present invention addresses this challenge by providing an intelligent tool that converts any visual language into any verbal language and vice-versa in real time while generating a realistic 3D actor on a realistic background which gives the realistic feeling as if the speaker is speaking in the listener's language. This tool enhances accessibility, inclusiveness, and promotes equal participation for hearing disabled individuals in settings such as meetings, conferences, classrooms, and public spaces, fostering understanding and collaboration among diverse groups with realistic appearance and feel.

### CROSS-REFERENCE TO RELATED APPLICATIONS

This application claims the benefit of U.S. Provisional Patent Application No. 63/741,967, filed Jan. 5, 2025, entitled “Smart Tool for Realistic Communication between Sign Languages and Natural Languages”, the entirety of which is incorporated herein by reference.

### TECHNICAL FIELD

The present disclosure relates generally to artificial intelligence-based communication systems, and more particularly to bidirectional translation between sign languages and natural languages using transformer-based neural networks and realistic three-dimensional (3D) avatar or actor generation in real time.

### BACKGROUND OF THE INVENTION

According to the World Health Organization (WHO), approximately 16% of the global population experience significant disabilities. A disability refers to any condition, whether physical or mental, that greatly affects an individual's daily activities. The most prevalent types of disabilities are those related to hearing, vision, mobility, and cognition. Hearing loss greater than 35 decibels (dB) in the better hearing ear is considered as disabling hearing loss. Hearing disability has a disproportionately negative effect on individuals who face obstacles to communication and speech, cognition, social isolation, loneliness, stigma, education and employment. In 2024, it was estimated that 430 million people worldwide experienced disabling hearing loss. This figure is anticipated to rise to about 509 million by 2030, 612 million by 2050, and 711 million by 2050.

Worldwide, deaf people use sign language as their first language, and it is also the first language to many hearing-impaired people. Sign languages are visual languages that use physical movements to communicate, including cues from the hands, eyes, facial expressions, and movements. They have grammar and structure rules, and they have evolved over time. There are more than 300 different sign languages spoken worldwide and no sign language is identical. But sign language is a fundamental means of communication for people with hearing or speech impairments. It is also becoming increasingly popular with hearing individuals. Sign languages are diverse, with different signs for the same word depending on the country or region. Even deaf people do not know different sign languages having different dialects. For example, in Singapore, you'd raise both hands to chest level and wiggle all ten fingers to sign “cool”, although some signs overlap—for example, thank you.

Sign language generation tools are essential for improving communication between deaf or hard-of-hearing individuals and those who do not know sign language. These tools can translate spoken or written language into sign language making conversations more accessible. By using such technology, we can bridge the gap between different communities and promote inclusion. Additionally, these tools can aid in education allowing students to learn and communicate more effectively. Overall, a sign language generation tool can enhance understanding and foster better relationships among people. But existing tools for sign language are limited to a few sign languages and the majority of them require a device to be worn by the person for the recognition of the sign. No previous invention supports realistic communication as well as support for conversion among many sign languages and many natural languages.

The present disclosure is harnessing intelligence in a digital tool by generating sign languages and natural languages with realistic actors and realistic backgrounds using generative AI for inclusion and accessibility. This invention does not require any specific device to wear for the recognition of signs.

The present disclosure, a smart sign language generation tool, is essential for people who are deaf or hard of hearing, as it provides them with a primary means of realistic communication, allowing them to fully participate in conversations and access information on an equal footing with others, thus enabling social inclusion and preserving Deaf culture; it also serves as a way to express themselves and connect with the wider community through a visual language with realistic feeling and real time conversion.

### SUMMARY OF THE INVENTION

Everyone including the person with hearing disability has the right to speak and express themselves in their own language. Everyone has the right to put their views and hear others' views with the same look and feel in meetings, conferences, video conferences, social/public gatherings, classrooms, hospitals, offices and wherever they go and participate in communication. But for communication to happen both should either know the language or need a translator, i.e. a sign language translator.

This invention, sign language generation tool, plays a crucial role in fostering communication and inclusivity for the deaf and hard of hearing community. Since a significant number of individuals rely on sign language as their primary mode of communication, this invention overcomes the challenges like a lack of understanding from those who do not know sign language, limited access to real-time translation services, and the need for more inclusive technology, especially in environments like meetings, conferences, educational settings, and public spaces. By this invention, we bridge communication gaps, enhance accessibility, and promote equal participation for disabled individuals in all aspects of society. This initiative not only empowers the deaf community but also enriches the broader social fabric by fostering understanding and collaboration among diverse groups.

This invention is to design a smart tool consisting of 3D realistic avatar/actor with realistic background using generative AI to convert sign language to natural language and vice-versa with following innovative features:
1. To convert speech/text/video in English or many other natural languages into American sign language and many other sign languages.
2. To convert text/video in one sign language to text/video in another sign language.
3. To convert American sign language and many other sign languages to speech/ text/video in English and many other natural languages.
4. To generate and embed the realistic 3D avatar/actor for communication to take place in both directions to provide a realistic feeling like the speaker is speaking in the listener's language.
5. To generate and embed realistic context/environment/background to provide realistic look and feel of the communication to take place in both directions.
6. To design and implement tools and make it accessible as web app, mobile application and plugins for existing applications.

This invention breaks all the communication barriers between people using verbal (natural) and visual (sign) languages. The invention is useful in the many but not limited to the following applications:

Online meet (google meet)/Video conferencing: Simultaneous and quick conversion of sign language and natural language during online meeting. The person communicating in sign language actually talks in sign language, but this invention/tool generates its version (video/audio as desired) in natural language with the avatar/actor carrying the person's look (skin) with the same background as the person has. Similarly, the person communicating in natural language actually talks in natural language, but this invention generates its version (video/ audio as desired) in sign language with the avatar/actor carrying the person's look (skin) with the same realistic background as the speaking person has. This invention gives a realistic feeling during communication.

Physical meeting: This invention shows the immediate sign language conversion of communication taking place in the physical meeting room on a mobile or big screen available in the meeting room. Here also the converted version has the realistic avatar/actor with realistic background

News: As we watch news in natural language, this invention generates its sign language variant and carries the same background, side news etc. along with the same anchor and dress etc. but using sign language.

Public places: The public places like airports, metro stations, bus stations. railway stations, government offices etc. where announcements are important, this invention shows the sign language conversion of the announcement on the screen.

Education/Classroom: This invention makes the classroom and the audio/video lecture contents accessible to everyone. A student can learn concepts in class with his/her classmates. This invention generates a live/real time sign language variant of the lecture delivered by the teacher in the classroom carrying the same background, along with the same teacher but using sign language. A teacher physically teaches a class, and the students watch its sign language variant on a screen in the classroom with a realistic feeling with his/her classmates.

Hospitals/banks etc.: Language should not come as a barrier in hospitals. Intelligence is in the brain not in communicating language. A patient/doctor can share his/her problem with the doctor/patient or vice versa. This invention provides ease in communication in hospitals and banks etc. This invention generates its sign language variant of the communication taking place so that both can quickly understand the problem and solve it.

Movies/songs etc.: Everyone enjoys watching movies in their own languages. Disabled people should also be able to watch the movie/song in sign language. This invention generates movies/songs composed in natural language into sign language. Using this invention, a disabled person is to be able to watch movies and songs in sign language but having the same actors, realistic background and effects to enjoy a realistic feel of the movies/songs.

### BRIEF DESCRIPTION OF DRAWINGS

FIG. 1 shows the overall conversions of the invention which is a realistic sign and natural language generator.

FIG. 2 shows overall capabilities and interrelation among the different modules in the invention.

FIG. 3 presents the major steps involved to convert video in natural language into text/video in sign language.

FIG. 4 presents the major steps involved to convert audio in natural language into text/video in sign language.

FIG. 5 presents the major steps involved to convert text in natural language into text/ video in sign language.

FIG. 6 presents the major steps involved to convert text/video in one sign language into text/video in another sign language.

FIG. 7 presents the major steps involved to convert text/video in sign language into text/audio/video in natural language.

### DETAILED DESCRIPTION OF THE INVENTION

This invention enables communication between everyone and with this invention the communication hindrance is the talk of the past. This invention provides communication between hearing-impaired people and non-hearing-impaired people with realistic feelings using generative AI. The present invention converts American sign language and many other sign languages to English and many other natural languages carrying 3D real avatar/actor on the real background, as well as converts English and many other natural languages to American sign language and many other sign languages carrying 3D real avatar/actor on the real background. The present invention has the following features:
1. Converts American sign language and many other sign languages into English and many other natural languages.
2. Converts one sign language into another sign language
3. Converts English and many other natural languages to American sign language and many other sign languages.
4. Input and output can be as text/audio/video.
5. Generates 3D Real avatar/actor which gives the realistic feeling as if the real person is speaking in the listener/other person's language.
6. Generates converted output on real context/environment/background.

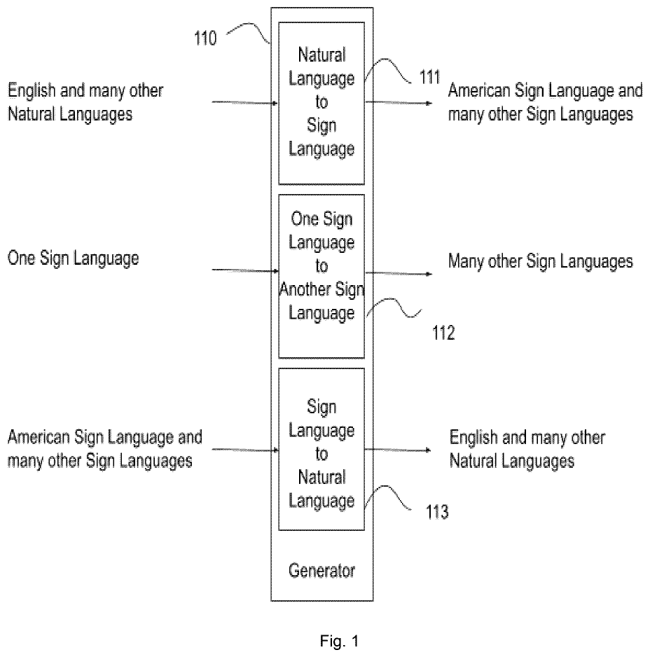

FIG. 1 shows the overall function of the invention which is a realistic sign and natural language generator 110. The present invention has three main components: Realistic natural language to sign language generator 111, Realistic sign language to another sign language generator 112 and Realistic sign language to natural language generator 113. These components (111, 112 and 113) convert American sign language and many other sign languages to English and many other natural languages carrying 3D real avatar on the real background as well as English and many other natural languages to American sign language and many other sign languages carrying 3D real avatar/actor on the real background respectively. Herein the input can be text/audio/ video and invention produces output in the same format as the input or as required.

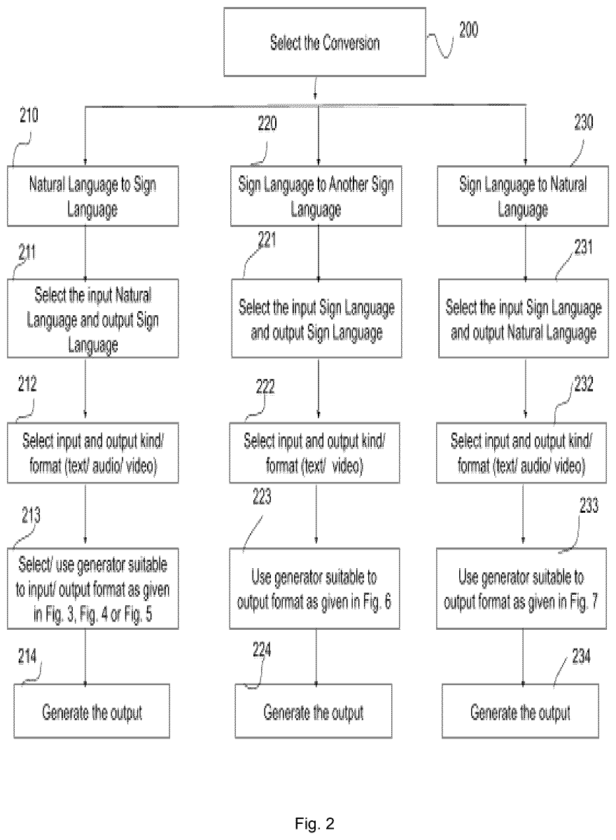

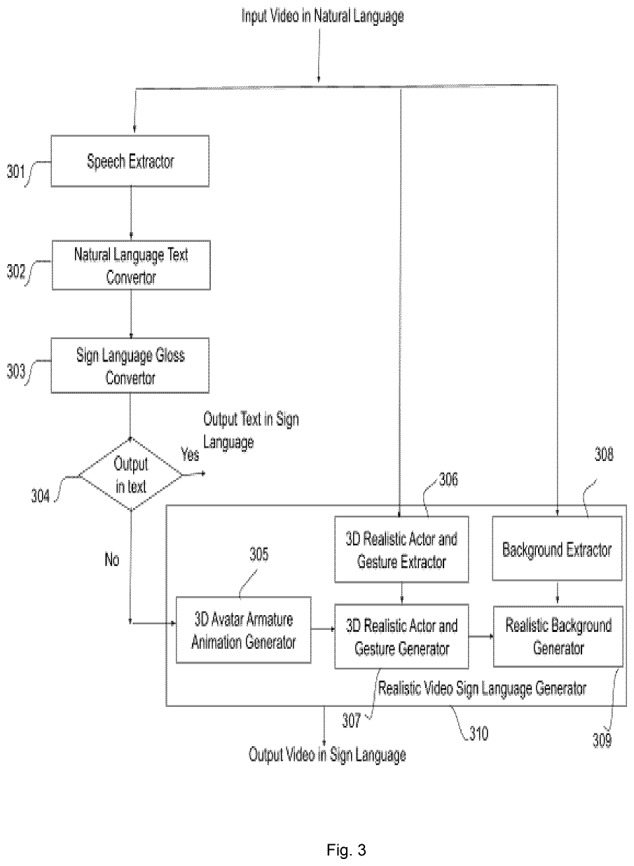

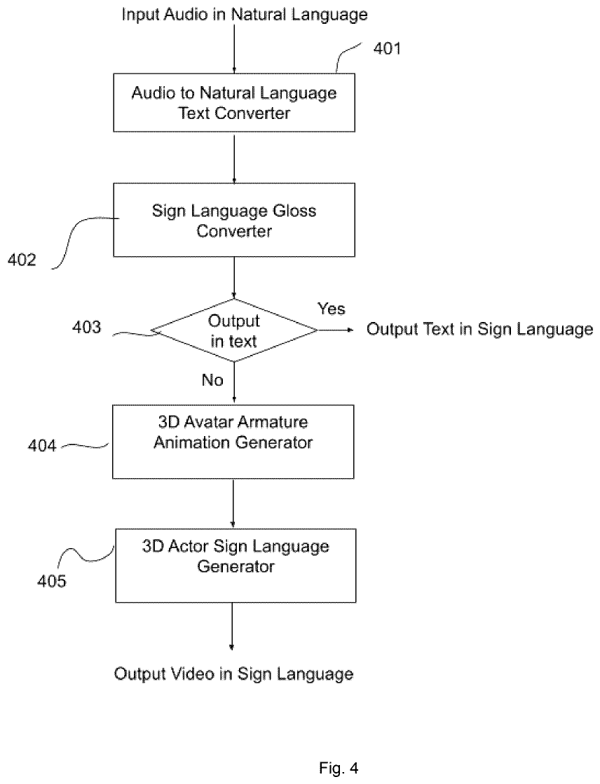

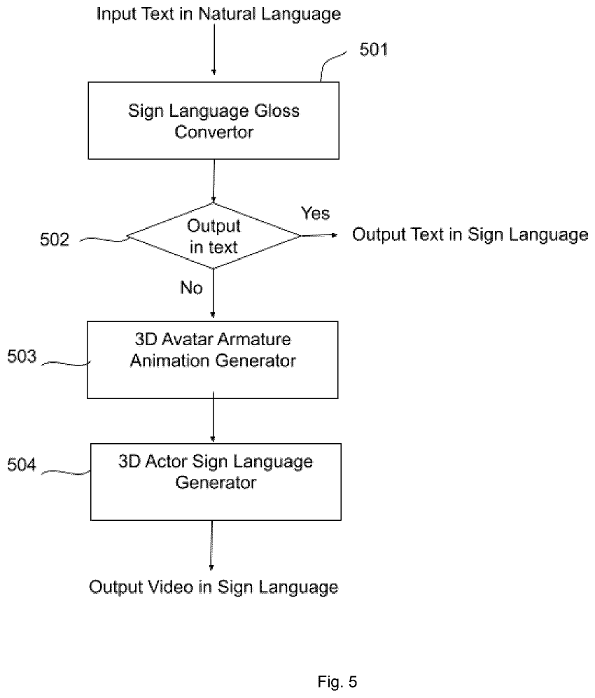

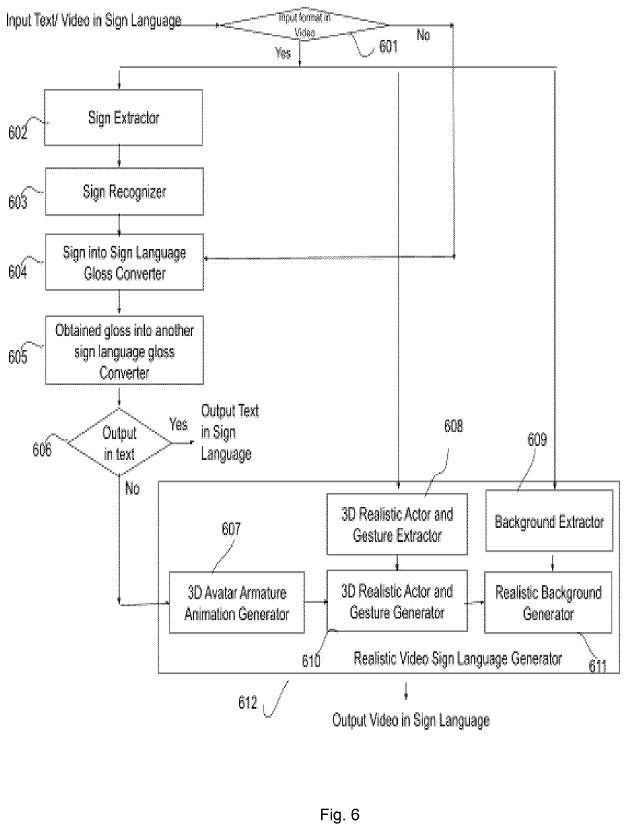

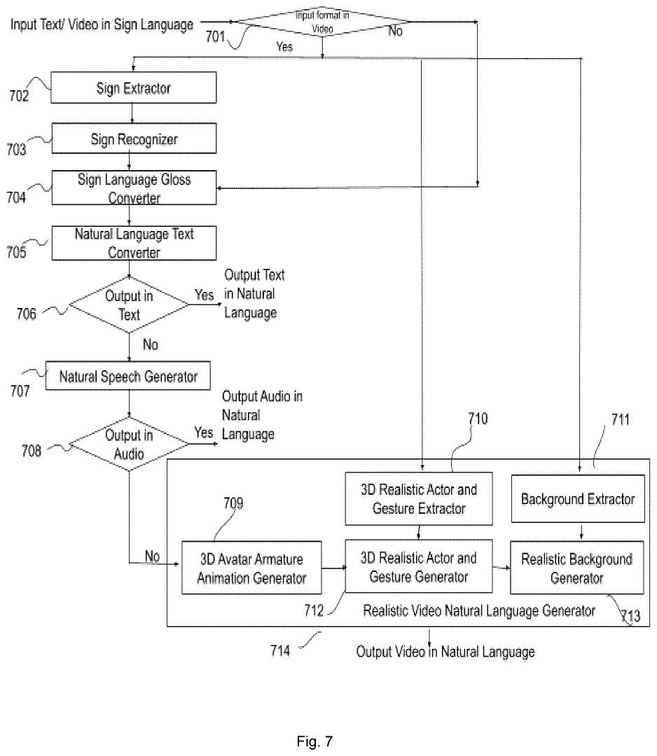

FIG. 2 presents the major steps involved in the invention. The first step is to select the conversion 200. The invention supports three kinds of conversion: natural language to sign language 210, sign language to another sign language 220 and sign language to natural language 230. This invention supports conversion among many natural languages and sign languages. Next step is to select input and output (natural and sign) languages like English and ASL. Input and output languages are selected under all three conversions (210, 220, 230) using 211, 221 and 231 respectively. 211 selects natural language from the list of natural languages provided (English etc.) as input language and selects output language from the list of sign languages provided (ASL etc.). Next step 212 is to select the format/kind of input and output. Since the input language is natural language, 212 selects kind of input among text, audio and video and since output language is sign language, 212 selects kind of output as either text or video. Generator selection step 213 selects the appropriate generator (as given in FIG. 3, FIG. 4 and FIG. 5) for conversion and the generation step 214 generates (realistic) sign language in the desired format. 221 selects input and output sign language from the list of sign languages provided (ASL, ISL etc.) as input and output language. Next step 222 is to select the format/kind of input and output. Since the input and output languages are sign languages, 222 selects the kind of input and output as either text or video. Generator selection step 223 selects the appropriate generator (as given in FIG. 6) for conversion, and the generation step 224 generates (realistic) sign language in the desired format. This module helps to support communication between two people using different sign languages. 231 selects sign language from the list of sign languages provided (ASL etc.) as input language and selects output language from the list of natural languages provided (English etc.). Next step 232 is to select the format/kind of input and output. Since the input language is sign language, 232 selects kind of input as either text or video and since output language is natural language, 232 selects kind of output among text, audio and video. Generator selection step 233 selects the appropriate generator (as given in FIG. 7) for conversion and the generation step 234 generates (realistic) natural language in the desired format.

FIG. 3 presents the major steps involved to convert video in natural language into text/realistic video in sign language. Speech extractor 301 extracts speech in natural language. Natural language text convertor 302 converts speech in natural language to text in natural language using natural language processing. sign language Gloss converter 303 converts text in natural language to text in sign language according to the syntax and semantics of the sign language. The output format is checked at 304. If the output in sign language is required as text, the sign language translation as text of the natural language is given as the output. If the required type of the sign language is video, realistic video sign language generator 310 generates the output video in sign language. Realistic sign language generator has five components: 3D Avatar Armature Animation Generator 305, 3D Realistic Actor and Gesture Extractor 306, 3D Realistic Actor and Gesture Generator 307, Background extractor 308 and Realistic Background generator 309. 3D Avatar Armature Animation Generator 305 generates animation on 3D armature for the text obtained in sign language by Gloss converter 303. 3D Realistic Actor and Gesture Extractor 306 extracts the actor along with gesture and Background extractor 308 extracts the background in the input video. 3D Realistic Actor and Gesture Generator 307 generates the animation on 3D realistic actor and follows the actors' gestures using LLMs. Realistic Background generator 309 adjusts the delay and related parameters of the real background and generates the aligned background so that speech in sign language can be mapped on it. Sign language Generator 310 generates the sign language conversion of the speech in natural language with 3D realistic actor and real background.

FIG. 4 presents the major steps involved to convert audio in natural language into text/video in sign language. Audio to natural language Text converter 401 converts audio/speech in natural language to text in natural language using natural language processing. sign language Gloss converter 402 converts text in natural language to text in sign language according to the syntax and semantics of the sign language. The output format is checked at 403. If the output in sign language is required as text, the sign language translation as text of the audio in natural language is given as output. If the required type of the sign language is video, 3D Avatar Armature Animation Generator 404 and 3D Actor sign language Generator 405 generates output video in sign language. 3D Avatar Armature Animation Generator 404 generates animation on 3D armature for the text obtained in sign language by Gloss converter 402. 3D Actor sign language Generator 405 generates the animation on 3D actor using LLMs.

FIG. 5 presents the major steps involved to convert text in natural language into text/video in sign language. sign language Gloss converter 501 converts text in natural language to text in sign language according to the syntax and semantics of the sign language. The output format is checked at 502. If the output in sign language is required as text, the sign language translation as text of the audio in natural language is given as output. If the required type of the sign language is video, 3D Avatar Armature Animation Generator 503 and 3D Actor sign language Generator 504 generates output video in sign language. 3D Avatar Armature Animation Generator 503 generates animation on 3D armature for the text obtained in sign language by Gloss converter 501. 3D Actor sign language Generator 504 generates the animation on 3D actor using LLMs.

FIG. 6 presents the major steps involved to convert text/video in one sign language into text/video in another sign language. The input format is checked at 601. If the input format is video, Sign Extractor 602 extracts signs in sign language. Sign Recognizer 603 recognizes signs and then sign language gloss converter 604 converts sign to text in sign language according to the syntax and semantics of the sign language. Next sign language Gloss Converter 605 converts gloss in one sign language to gloss in another sign language. If the desired output format is text which is checked at the output format checker 606, output text in sign language is obtained. If the required type of the sign language is video, realistic video sign language generator 612 generates the output realistic video in sign language. Realistic sign language generator has five components: 3D Avatar Armature Animation Generator 607, 3D Realistic Actor and Gesture Extractor 608, Background extractor 609, 3D Realistic Actor and Gesture Generator 610 and Realistic Background generator 611. 3D Avatar Armature Animation Generator 607 generates animation on 3D armature for the text obtained in sign language by Gloss converter 605. 3D Realistic Actor and Gesture Extractor 608 extracts the actor along with gesture and Background extractor 609 extracts the background in the input video. 3D Realistic Actor and Gesture Generator 610 generates the animation on 3D realistic actor and follows the actors' gestures using LLMs. Realistic Background generator 611 adjusts the delay/speed and related parameters of the real background and generates the aligned background so that video in another sign language can be mapped on it. Sign language Generator 612 generates the sign language conversion of the video in sign language with 3D realistic actor and realistic background.

FIG. 7 presents the major steps involved to convert text/video in sign language into text/audio/video in natural language. The input format is checked at 701. If the input format is video, Sign Extractor 702 extracts signs in sign language. Sign Recognizer 703 recognizes signs and then sign language gloss converter 704 converts sign to text in sign language according to the syntax and semantics of the sign language. Natural Language converter 705 converts text in sign language to text natural language using NLP. If the desired output format is text which is checked at the output format checker 706, output text in natural language is obtained. Natural Speech Generator 707 generates speech in the natural speech for the text obtained in natural language. If the desired output format is audio which is checked at the output format checker 708, output audio in natural language is obtained. If the required type of the sign language is video, realistic video natural language generator 714 generates the output realistic video in natural language. Realistic natural language generator has five components: 3D Avatar Armature Animation Generator 709, 3D Realistic Actor and Gesture Extractor 710, Background extractor 711, 3D Realistic Actor and Gesture Generator 712 and Realistic Background generator 713. 3D Avatar Armature Animation Generator 709 generates animation on 3D armature for the text obtained in natural language. 3D Realistic Actor and Gesture Extractor 710 extracts the actor along with gesture and Background extractor 711 extracts the background in the input video. 3D Realistic Actor and Gesture Generator 712 generates the animation on 3D realistic actor and follows the actors' gestures using LLMs. Realistic Background generator 713 adjusts the speed and related parameters of the real background and generates the aligned background so that speech in natural language can be mapped on it. Realistic Video natural language Generator 714 generates the natural language conversion of the speech in sign language with 3D realistic actor and realistic background.

1. A smart tool capable of doing the following conversions:
Text/audio/video in English or many other natural languages into text/ video in American sign language or many other sign languages;
Text/video in one sign language into text/video in another sign language; and
Text/video in American sign language or many other sign languages into text/audio/video in English or many other natural languages,
Includes/generates realistic 3D avatar/actor for communication to take place in both directions which gives the realistic feeling as if the real person is speaking in the listeners/other person's language;
Carries realistic context/environment/background for providing realistic look and feel of the communication to take place in both directions;
Uses natural language processing and generative AI to perform the translation and provide a realistic feel; and
Tool accessibility as web application, mobile application and plugins for existing applications.
